(19) United States
(12) Patent Application Publication
(10) Pub. No.: US 2003/0042148 A1
(43) Pub. Date: Mar. 6, 2003

(54) Method and apparatus for anodizing aluminium exhaust housings

(75) Inventors: Kenneth Wickenheiser, Carleton, MI (US); Thomas B. Poiry, Fort Wayne, IN (US)

Correspondence Address: Detroit Diesel Corporation, 13400 West Outer Drive, Detroit, MI, 48239-4001, US

(73) Assignee: Detroit Diesel Corporation

(21) Appl. No.: 09/943,303

(22) Filed: Aug. 31, 2001

(51) Int. Cl. C25D 9/00; C25D 11/00; B27K 3/02

(52) U.S. Cl. 205/333; 118/506

(57) ABSTRACT

A method and apparatus for anodizing aluminum exhaust housings including the utilization of conducting rods placed through the narrow passages. The rods allow current to flow and anodizing coating to build up inside the narrow passages. The rods are insulated from the housing and are connected to a special end plate. The end plate has an insulating spacer between the housing and connecting plate and ensures that the rods are installed and spaced properly and that the current properly flows. The assembly is then degreased and rinsed. The clean assembly is then placed into an appropriate anodizing solution and connected to a current source until the coating sufficiently builds up. The assembly is then removed from the anodizing tanks and rinsed in a series of tanks of increasing temperature.

### BACKGROUND OF THE INVENTION

1. Field of the Invention

The present invention relates to an exhaust housing for a row of cylinders of an internal combustion engine, made of a light metal, including narrow cooling passages treated to deter corrosion and a method for treating the narrow passages. Exhaust housings for internal combustion engines with cooling passages are used in environments where the outer surface temperature of the housing must be kept low for safety or other reasons. This includes but is not limited to marine applications. Exhaust housings have historically been made of cast iron. These designs have the disadvantage of being very heavy. The use of lightweight materials including but not limited to aluminum, solved the weight problem but created other problems such as but not limited to galvanic corrosion and pitting due to cavitation. These problems are especially prevalent in the narrow cooling passages.

2. Description of the Related Art

U.S. Pat. No. 5,305,603 teaches of a water-cooled exhaust gas housing made from a lightweight metal. It teaches the use of a semi-finished, extruded standardized sectional stock with the benefits of being able to make the extrusion with high dimensional precision, with a high surface quality. It teaches the use of an exhaust gas pipe section mounted in the interior of the cooled housing in such a manner that the thermal expansion of the gas pipe relative to the housing does not cause excessive corrosion, especially fretting between the exhaust pipe and the housing. However, it does not teach of the potential corrosion problems within the narrow cooling passages such as but not limited to galvanic corrosion and pitting due to cavitation. It also does not teach to coat or anodizing any surface of the housing including the interior of the narrow cooling passages.

U.S. Pat. No. 5,600,950 similarly teaches of a water-cooled exhaust gas housing with an exhaust gas pipe section mounted in the interior of the cooled housing. It teaches that the mounting system will be economical, simple to mount and will solve vibration problems. However, it also does not teach of the potential corrosion problems within the narrow cooling passages such as but not limited to galvanic corrosion and pitting due to cavitation. It also does not teach to coat or anodizing any surface of the housing including the interior of the narrow cooling passages.

U.S. Pat. No. 5,311,738 teaches of a water-cooled exhaust gas housing made from a lightweight metal. It teaches the use of a semi-finished, extruded standardized sectional stock with the benefits of being able to make the extrusion with high dimensional precision, with a high surface quality. It teaches the use of an exhaust gas pipe section mounted in the interior of the cooled housing that is compact in design. This reference addresses the corrosion problem by disclosing that the entire housing is provided on its surface with a corrosion protective coating. The problem with this teaching is twofold. First, it does not discuss the galvanic corrosion or pitting problems that the narrow cooling passages are subject to. Second, it does not disclose a method of uniformly anodizing the interior of the narrow cooling passages to help alleviate these problems. If you coat the housing on its surface by dipping the housing into an anodizing bath, the coating will only travel a short distance into the narrow cooling passages.

The problems that this reference, as well as the previous two, do not solve, is that by not coating the interior of the narrow passages that the coolant flows through, the passages are subject to high rates of pitting from cavitation and galvanic corrosion from the coolant and the dissimilar metals present in the coolant.

It is the object of the present invention to provide an exhaust housing made from a light metal including narrow cooling passages, wherein the cooling passages are uniformly coated to prevent corrosion and a method to coat the passages uniformly.

### SUMMARY OF THE INVENTION

The object has been achieved by teaching that the interior of the narrow cooling passages are to be anodized with a uniform coating and by teaching both a method and an apparatus for anodizing the narrow passages uniformly.

One method for anodizing the interior of the narrow passages involves first installing the conducting rods into the narrow passages. The conducting rods are crucial because anodizing is an electrochemical conversion process. The rods must be placed into the narrow passages to allow the electricity to flow and the conversion process to occur. It is important that the rods be properly insulated so that contact with the housing does not occur. The assembly is then degreased and rinsed. The assembly is then placed into an anodizing bath and current is applied for a sufficient amount of time to build up the desired coating. The assembly is then rinsed in city tap water in a series of one cold and two warm constant flow rinse tanks to clean the anodizing solution off. The temperature of the assembly is thus raised slowly to avoid thermal shock to the coating.

The apparatus used to anodize the narrow passages is designed to allow the rods to be installed and spaced properly and to ensure that the current is flowing through the rods correctly. The apparatus has an insulating stand off spacer attached to the housing with at least one insulating hold down bolt. These insulating pieces ensure that the current flows through the rods and does not flow through the housing. A conducting connecting plate is placed on the side of the insulating spacer away from the housing and is used to connect the rods and allow current to flow through the rods.

After using the method and apparatus described in detail below, the housing is now completely and uniformly anodized on all surfaces, especially inside the narrow cooling passages. This has the advantage of being more resistant to pitting from cavitation and galvanic corrosion from the coolant and the dissimilar metals present in the coolant in the narrow passages.

### BRIEF DESCRIPTION OF THE DRAWINGS

The invention will now be described in detail in the following with reference to example embodiments illustrated in the accompanying drawings, wherein:

FIG. 1 shows a section of an exhaust gas housing;

FIG. 2 a cross-section of the exhaust housing shown in FIG. 1 as section A-A;

FIG. 3 shows a cross section of the end plate assembly.

### DETAILED DESCRIPTION OF A PREFERRED EMBODIMENT

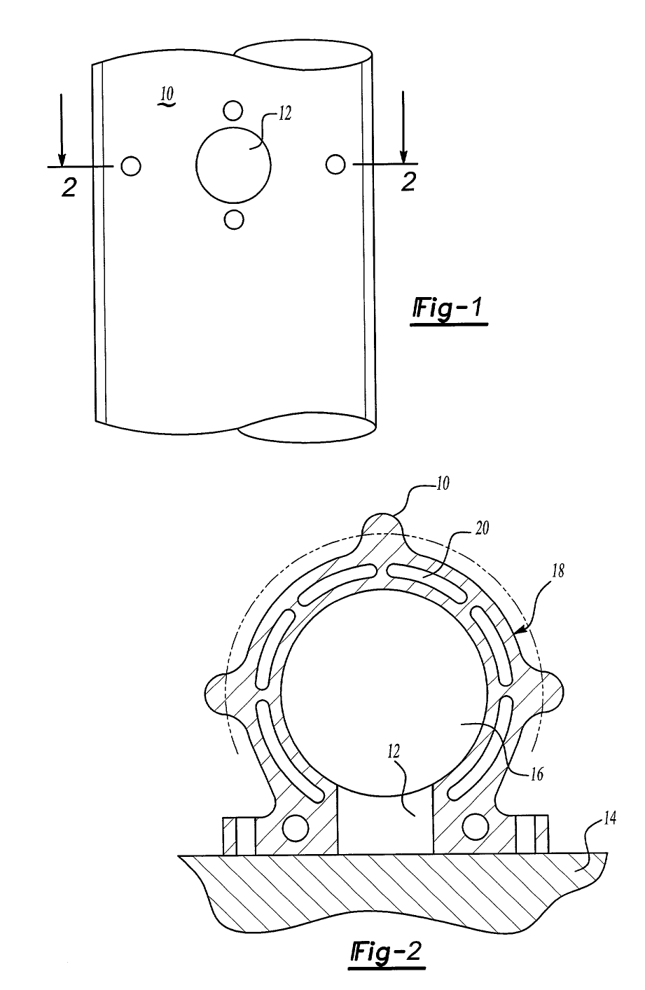

Referring to FIGS. 1 and 2, wherein like numbers refer to like structures, exhaust housing 10 is formed from a single piece aluminum extrusion its length being substantially greater than its width. This extrusion is cut to the appropriate length depending on the number of cylinders in an internal combustion engine. Exhaust passages 12 are machined to allow the flow of exhaust gasses from the mating cylinder head 14 into the housing inner diameter 16 extending substantially the entire length of the housing 10. The housing 10 has an outer surface 18 formed by the extrusion process, the cross section of which is substantially circular and contains a number of longitudinal narrow cooling liquid chambers 20 extending substantially the entire length of the housing 10.

The housing interior 16 and exterior 18 surfaces and especially the interior of the narrow cooling passages 20 must be uniformly coated to prevent corrosion. Nickel coating could be used but is not preferred because it is costly and difficult to adhere to the aluminum. Hard coat anodizing (hereafter referred to as anodizing) is preferable because it provides a surface that is durable, hard, uniform, and corrosion resistant.

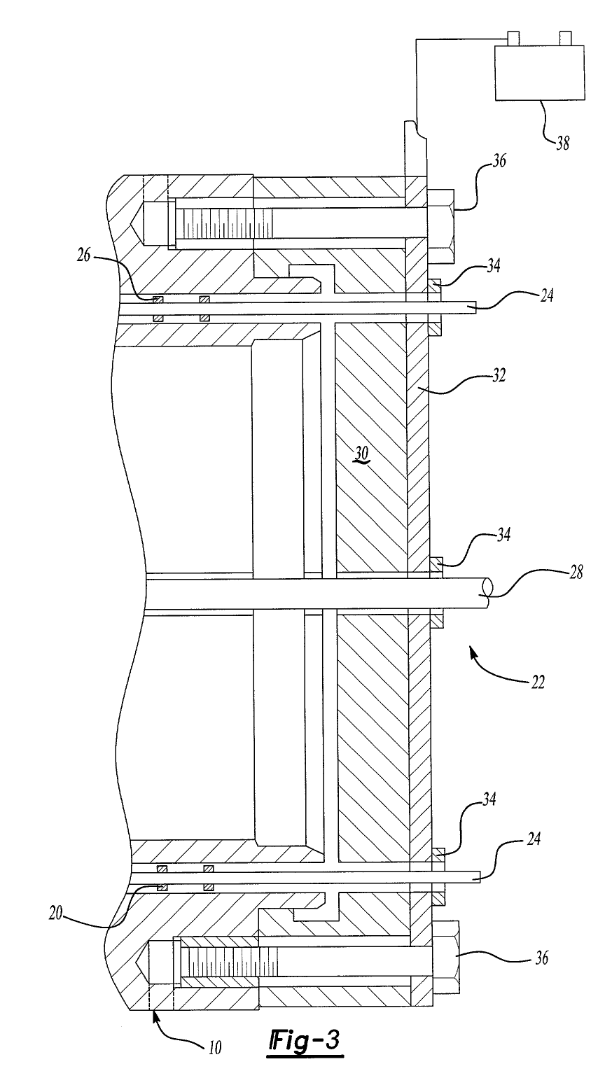

Anodizing the housing interior 16 and exterior 18 surfaces can be achieved with the conventional anodizing practices described below, and known by those skilled in the art, without the need for any special methods or apparatus. Anodizing the interior of the narrow cooling passages 20 along with the housing interior 16 and exterior 18 surfaces requires a special method and apparatus 22 shown in FIG. 3.

The housing 10 is first prepped to anodize the interior of the narrow cooling passages 20 using the apparatus outlined in FIG. 3. The titanium conducting rods 24 with insulating o-ring spacers 26 are placed into the narrow cooling passages 20. Another titanium rod 28 is placed through the interior surface of the housing 16. The insulating stand off spacer 30 and the conducting connecting plate 32 are then placed on the end of the housing with the titanium conducting rods 24 passing through the thickness of the spacer 30 and connecting plate 32 with sufficient length to allow the titanium conducting rods 24 and 28 to be attached to the conducting connecting plate 32 with titanium spacers and nuts 34. The apparatus 22 is attached to the housing 10 with insulating hold down bolts 36. The insulating o-ring spacers 26 are made of rubber or neoprene or any material with similar and sufficient insulating properties. The insulating stand off spacer 30 is made of polypropylene or any material with similar and sufficient insulating properties and of sufficient strength to support the housing 10 and avoid contact between the housing 10 and the conducting connecting plate 32. The housing 10 and apparatus 22 will hereafter be referred to as the assembly.

The method for anodizing then involves degreasing the assembly by placing it in an alkaline base cleaner for about 5 minutes or for a time sufficient to adequately remove any grease, the cleaner being at a temperature of about 160 degrees Fahrenheit. The alkaline base cleaners come in a variety of different chemical forms but most have a ph of about 7-8 and a person skilled in the art of anodizing could pick the appropriate degreaser from their local chemical supply company that would adequately degrease the housing. The assembly is then rinsing for about 4 minutes, or for a time sufficient to adequately remove any base cleaner, in a constant over-flowing rinse tank. The purpose of the constant overflow is to keep the base cleaner rinsed off out of the rinse tanks.

The assembly is then placed in the anodizer and the connecting plate 32 is connected to a current source 38. The current source is known to those skilled in the art to be about 35 amps per square foot of part surface plus or minus about 5 amps. The anodizer is made up of about 14-17% by volume H₂SO₄, about 7-9% by volume additive #1332 and the balance H₂O. Additive 1332 is a proprietary additive from Southern Industrial Chemical, Inc., of Atlanta Ga. The additive is used to facilitate increased amperage during anodization to promote a thicker coating with fewer open cell areas without burning the piece to be anodized. The additive aids the development of thicker coatings at the lower temperatures used in the process. The temperature of the anodizer is maintained in a range of about 28-32 degrees Fahrenheit. It is important to stay under 32 degrees Fahrenheit because the coating gets softer and there are difficulties achieving the desired thicknesses if higher temperatures are used. If temperatures below 28 degrees Fahrenheit are used, the hard coating formed is more likely to crack. The assembly is then anodized for about 30 minutes, or for a time sufficient to build up a uniform thickness of about 0.0012″. The assembly is then rinsed in city tap water in a series of one cold and two warm constant flow rinse tanks for five minutes in each tank. Constant flow rinse tanks are used to keep the acids rinsed off the assembly out of the rinse tanks. The sequence of cold tank to warm is used to raise the temperature of the assembly slowly to avoid thermal shock to the coating. The first tank's temperature is about 40-45 degrees Fahrenheit. The second tank's temperature is about 55-65 degrees Fahrenheit. The third tank's temperature is about room temperature.

Although the invention has been described with reference to specific example embodiments it will be appreciated that it is intended to cover all modifications and equivalents within the scope of the appended claims.

We claim:

1. A method for anodizing an exhaust housing; said housing having a length substantially greater than its width, and narrow passages extending substantially along the entire length of the housing; said passages having an interior and an exterior; said method to deposit a coating of substantially uniform thickness along the interior length of the said passages comprising:
a. installing conducting rods into the narrow passages substantially along the length of the said exhaust housing;
b. degreasing the exhaust housing assembly;
c. connecting said rods to a source of current;
d. placing said exhaust housing assembly into an anodizer;
e. applying sufficient amperage of current for a time sufficient to deposit a uniform coating along substantially the entire length of the passages;
f. rinsing said exhaust housing assembly when the desired uniform thickness of said coating is achieved.

2. The method of claim 1, wherein the method of degreasing is comprised of placing said exhaust housing in an alkaline base cleaner for about 5 minutes at about 160 degrees Fahrenheit and then rinsing for about 4 minutes in a constant over-flowing rinse tank.

3. The method of claim 2, wherein said alkaline base cleaner has a pH of about 7-8.

4. The method of claim 1, wherein the conducting rods are made of a conducting material of sufficient diameter to allow sufficient current to flow and yet allowing sufficient space between the rods and interior walls of the passage so that contact does not occur.

5. The method of claim 4, wherein the conducting rods are made of titanium.

6. The method of claim 1, further including nonconducting spacer means in spaced relation to each other along said rod to prevent contact with the interior walls of the passage.

7. The method of claim 6, wherein the said spacer means are comprised of rubber O-rings.

8. The method of claim 1, further including connecting said rods to an end plate assembly to ensure proper installation and spacing and to ensure that the current is flowing through the rods correctly.

9. The method of claim 1, wherein the current source supplies about 35 amps per square foot of part surface.

10. The method of claim 1, wherein the time to deposit a uniform coating is about 30 minutes.

11. The method of claim 1, wherein said anodizing solution is maintained at about 28-32 degrees Fahrenheit.

12. The method of claim 1, wherein said anodizer comprises a solution of about 14-17% by volume H₂SO₄, about 7-9% by volume of an additive to promote increased amperage during anodization; and the balance H₂O.

13. The method of claim 1, wherein said uniform coating has a thickness of about 0.0012″.

14. The method of claim 1, wherein the rinsing sequence comprises using city tap water in a series of one cold and two warm constant flow rinse tanks for five minutes in each tank, the first tank's temperature being about 40-45 degrees Fahrenheit, the second tank's temperature being about 55-65 degrees Fahrenheit, and the third tank's temperature being about room temperature.

15. An apparatus to anodize narrow passages of the exhaust housing comprising an end plate assembly consisting of:
a. an insulating stand off spacer;
b. at least one insulating hold down bolt;
c. a conducting connecting plate for continuity between passages;
d. at least one conducting rod.

16. The apparatus of claim 15, wherein the insulating stand off spacer is comprised of a non-conducting material of sufficient diameter to cover the end of the housing and of sufficient thickness to insulate the housing from the conducting connecting plate and with at least one hole spaced so that the insulating hold down bolts may pass through to the housing

17. The apparatus of claim 15, wherein the insulating stand off spacer consists of a polypropylene material.

18. The apparatus of claim 15, wherein the conducting rods are attached to the conducting end plate to ensure proper installation and spacing and to allow sufficient current to flow through the plate to the rods.

19. The apparatus of claim 15, wherein the conducting rods are attached to the conducting end plate using titanium spacers and nuts.
